(19) United States
(12) Patent Application Publication
(10) Pub. No.: US 2008/0227594 A1
(43) Pub. Date: Sep. 18, 2008

(54) Hydraulic system for controlling a belt-driven conical-pulley transmission

(75) Inventors: Roshan Willeke, Karlsruhe (DE); Eric Muller, Kaiserslautern (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/072,135

(22) Filed: Feb. 21, 2008

Related U.S. Application Data
(60) Provisional application No. 60/902,561, filed on Feb. 21, 2007.
(60) Provisional application No. 60/902,562, filed on Feb. 21, 2007.
(60) Provisional application No. 60/902,563, filed on Feb. 21, 2007.
(60) Provisional application No. 60/919,398, filed on Mar. 22, 2007.
(60) Provisional application No. 60/937,273, filed on Jun. 26, 2007.
(60) Provisional application No. 60/937,274, filed on Jun. 26, 2007.
(60) Provisional application No. 60/937,275, filed on Jun. 26, 2007.
(60) Provisional application No. 60/937,276, filed on Jun. 26, 2007.

(51) Int. Cl. F16H 61/662

(52) U.S. Cl. 477/46

(57) ABSTRACT

A hydraulic system for controlling a belt-driven conical-pulley transmission of a motor vehicle, wherein the transmission has a variably adjustable transmission ratio. The hydraulic system includes a first valve arrangement to ensure a contact pressure in the belt-driven conical-pulley transmission, a second valve arrangement to control the transmission ratio of the belt-driven conical-pulley transmission, and a hydraulic energy source to supply the hydraulic system with hydraulic energy. In order to provide an improved hydraulic system, the system a third valve arrangement for controlling a forward clutch and a reverse clutch.

### BACKGROUND OF THE INVENTION

1. Field of the Invention

The present invention relates to a hydraulic system for controlling a belt-driven conical-pulley transmission (CVT) of a motor vehicle having a variably adjustable transmission ratio. The hydraulic system includes a first valve unit to ensure a contact pressure of the belt-driven conical-pulley transmission, a second valve unit to control the transmission ratio of the belt-driven conical-pulley transmission, and a hydraulic energy source to supply the hydraulic system with hydraulic energy. The present invention also relates to a belt-driven conical-pulley transmission controlled thereby and to a motor vehicle equipped therewith.

2. Description of the Related Art

Belt-driven conical-pulley transmissions can have a continuously variable transmission ratio, in particular automatically effected transmission ratio variation.

Such continuously variable automatic transmissions include, for example, a startup unit, a reversing planetary gearbox as the forward/reverse drive unit, a hydraulic pump, a variable speed drive unit, an intermediate shaft, and a differential. The variable speed drive unit includes two pairs of conical disks and an encircling member. Each conical disk pair includes one conical disk that is movable in an axial direction. Between the pairs of conical disks runs the encircling element, for example a steel thrust belt, a tension chain, or a drive belt. Axially moving the movable conical disk changes the running radius of the encircling member, and thus the transmission ratio of the continuously variable automatic transmission.

Continuously variable automatic transmissions require a high level of contact pressure applied to the encircling member in order to be able to move the axially movable conical disks of the variable speed drive unit with the desired speed at all operating points, and also to transmit the torque with sufficient basic pressure with minimum wear.

An object of the present invention is to provide a hydraulic system for a belt-driven conical-pulley transmission and/or a belt-driven conical-pulley transmission that has a hydraulic shift-by-wire control and that can replace mechanical actuation of the parking lock and the clutch selection.

### SUMMARY OF THE INVENTION

The above-identified object is achieved with a hydraulic system in accordance with the present invention for controlling a belt-driven conical-pulley transmission of a motor vehicle having a variably adjustable transmission. The hydraulic system includes a first valve arrangement to ensure a desired belt contact pressure in the belt-driven conical-pulley transmission, a second valve arrangement to control the transmission ratio of the belt-driven conical-pulley transmission, a hydraulic energy source to supply the hydraulic system with hydraulic energy, and a third valve arrangement to control a forward and a reverse clutch. The forward clutch and the reverse clutch are parts of a power train of the motor vehicle, and can optionally be actuated by means of the third valve arrangement, wherein the motor vehicle moves forward when the forward clutch is actuated and the motor vehicle moves backward when the reverse clutch is actuated. A mechanical intervention by means of a gearshift lever operable by a driver of the motor vehicle, for example, is not necessary to engage the forward or reverse gear of the motor vehicle.

The object of the present invention is also achieved with a hydraulic system for controlling a belt-driven conical-pulley transmission of a motor vehicle having a variably adjustable transmission, wherein the hydraulic system includes a first valve arrangement to ensure a belt contact pressure of the belt-driven conical-pulley transmission, a second valve arrangement to control the transmission ratio of the belt-driven conical-pulley transmission, a hydraulic energy source to supply the hydraulic system with hydraulic energy, and a parking-lock release system to control a parking lock. The parking lock is normally produced by a mechanical intervention of an appropriate component, for example a cog, in the drive train of the motor vehicle. Advantageously, the mechanical parking lock can be actuated, i.e., engaged or released again, by means of the parking-lock release system. A mechanical intervention that would require comparatively high manual force by a driver of the motor vehicle to operate the parking lock is not necessary.

A preferred exemplary embodiment of the hydraulic system is characterized in that the third valve arrangement includes a first valve with a first control piston for hydraulic actuation of the forward and reverse clutches. By means of the control piston, the forward and the reverse clutch can optionally be supplied with hydraulic energy to engage or disengage them, or it can be cut off from the hydraulic energy source.

Another preferred exemplary embodiment of the hydraulic system is characterized in that the hydraulic parking-lock release system has a second valve for hydraulic actuation of a parking lock cylinder positioned downstream from the second valve, to actuate the parking lock manually. The parking lock cylinder can be connected mechanically to the power train of the motor vehicle. To that end a lever connected to a transmission shaft can be engaged with a corresponding recess of the parking lock cylinder, for example.

Another preferred exemplary embodiment of the hydraulic system is characterized in that the third valve arrangement includes a third valve positioned upstream from the first valve to actuate the first control piston of the first valve. The third valve can be a control valve, for example an electrically actuatable proportional valve. By means of the actuation by the third valve, the forward or the reverse gear of the motor vehicle can optionally be engaged by selective actuation of the forward or reverse clutch.

Other preferred exemplary embodiments of the hydraulic system are characterized in that by means of the first control piston of the first valve the following are optionally alternatively actuatable:

a first selector position (R) to apply pressure to the reverse clutch and switch the forward clutch to zero pressure;

a second selector position (N) to switch the forward and reverse clutches to zero pressure; and

a third selector position (D) to apply pressure to the forward clutch and switch the reverse clutch to zero pressure

The forward and reverse clutches can be clutches that are disengaged when unpressurized. However, it is also conceivable to design the reverse and forward clutches so that they are engaged when unpressurized. Accordingly, in the second selector position the control piston could be switched so that both clutches are under pressure. When the forward and reverse clutches are designed as clutches that are disengaged when unpressurized it results in a safety benefit, since in the event of a possible occurrence of a pressure loss of the hydraulic energy source the neutral position results without further action, i.e., unpressurized forward and reverse clutches, whereby the vehicle can continue to move in free wheeling.

Another preferred exemplary embodiment of the hydraulic system is characterized in that the hydraulic parking-lock release system includes a fourth valve positioned upstream from the second valve to actuate a second control piston of the second valve. The fourth valve can also be a control valve, for example an electrically actuatable proportional valve.

Another preferred exemplary embodiment of the hydraulic system is characterized in that a sensor is provided to detect the first through third selector positions (R, N, D) of the first control piston. Advantageously, by means of the sensor the actual switch states of the first control piston can be recognized and can be conveyed for further processing. The data thus obtained can be used for a display of the selector position that is actually chosen, for example. From the aspect of safety, it is possible to use the data that are obtained to recognize possibly unwanted intermediate states or an unwanted selector position. For example, if an unwanted selector position results, that condition can be utilized to initiate an emergency function, for example emergency shutoff.

Another preferred exemplary embodiment of the hydraulic system is characterized in that the sensor includes a Hall-effect sensor to detect a position of the first control piston. The Hall-effect sensor can be employed as an additional safety device, and it can work together with a corresponding magnet attached to the first control piston, for example. The Hall-effect sensor, as an additional part of the sensor, can generate other safety-relevant information.

Another preferred exemplary embodiment of the hydraulic system is characterized in that the first valve is connectable upstream with the hydraulic energy source through a fifth valve. The supply of hydraulic energy to the first valve can be controlled by means of the fifth valve.

Another preferred exemplary embodiment of the hydraulic system is characterized in that the first valve is connectable downstream to a sixth valve to actuate the fifth valve. The fifth valve can be actuated by means of the sixth valve, which can be designed as a control valve, for example as an electrically actuatable proportional valve. It is conceivable to design the fifth valve so that by a corresponding control of the sixth valve it completely separates the first valve from the hydraulic energy source, and at the same time switches the first valve to the tank. That can be used advantageously as an emergency shutoff, wherein the reverse clutch and the forward clutch can be switched to zero pressure and therefore disengage, with the belt-driven conical-pulley transmission being shifted automatically to the neutral position. As an additional safety provision, it is conceivable to design the first control piston of the first valve so that in the unpressurized state, i.e., without control pressure from the third valve, it moves automatically into a selector position in which the forward and reverse clutches are switched to zero pressure.

Another preferred exemplary embodiment of the hydraulic system is characterized in that a fourth valve arrangement is provided to control a volumetric flow of cooling oil, in particular for cooling the clutches. Components of the power train, for example the forward and reverse clutches, a centrifugal oil cover, and/or the conical disks, as well as the encircling element of the belt-driven conical-pulley transmission, can advantageously be subjected to a controlled volumetric flow of cooling oil by means of the fourth valve arrangement.

Another preferred exemplary embodiment of the hydraulic system is characterized in that the fourth valve arrangement produces actuation of the fourth valve. The fourth valve can thus simultaneously actuate the second valve and the fourth valve arrangement. Advantageously, the fourth valve, as a proportional valve, can be designed so that when the parking-lock release system is released, i.e., when the motor vehicle is being driven, a volumetric flow of cooling oil takes place. It is conceivable to design the fourth valve as a proportional valve, wherein the valves connected downstream are activated earlier by the second valve to release the parking lock than another valve to control the volumetric flow of cooling oil. It is thus possible to only disengage the parking lock, without thereby being required to connect a volumetric flow of cooling oil. When the cooling oil volumetric flow is connected, however, because of the coupling the parking lock is necessarily also released.

The object is also achieved with a belt-driven conical-pulley transmission having a hydraulic system as described above.

The object is also achieved with a motor vehicle having a belt-driven conical-pulley transmission as described above.

### BRIEF DESCRIPTION OF THE DRAWINGS

The structure, operation, and advantages of the present invention will become further apparent upon consideration of the following description taken in conjunction with the accompanying drawings, in which:

FIG. 1 is a hydraulic circuit diagram of an embodiment of a hydraulic system in accordance with the present invention for controlling a belt-driven conical-pulley transmission; and

FIG. 2 is a longitudinal cross-sectional view of a first valve for actuating a forward and a reverse clutch, with a Hall-effect sensor for detecting a position of a first control piston of the first valve.

### DESCRIPTION OF THE PREFERRED EMBODIMENTS

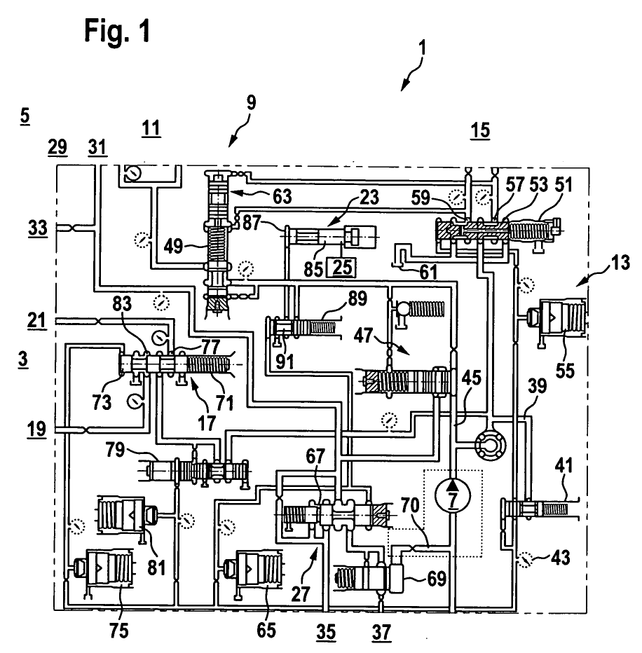

FIG. 1 shows a portion of a circuit diagram of a hydraulic system 1 in accordance with an embodiment of the present invention. Hydraulic system 1 is used to control a belt-driven conical-pulley transmission, which is indicated generally by reference numeral 3 in FIG. 1. Belt-driven conical-pulley transmission 3 can be part of a power train of a motor vehicle, which is indicated by reference numeral 5. Hydraulic system 1 includes a hydraulic energy source 7, for example a mechanically or electrically driven hydraulic pump to deliver a hydraulic medium. For a drive source, the hydraulic energy source 7 can be connected to an internal combustion engine (not shown) of the motor vehicle 5. Hydraulic energy source 7 serves to supply hydraulic system 1 with hydraulic energy.

Connected downstream from hydraulic energy source 7 is a first valve arrangement 9, which is connected to a torque sensor, indicated generally by reference numeral 11. First valve arrangement 1 and torque sensor 11 serve to provide and/or control a contact pressure to transfer torque between conical disks and a corresponding encircling element of belt-driven conical-pulley transmission 3, particularly as a function of the torque present at belt-driven conical-pulley transmission 3. Downstream, torque sensor 11 is connected through a cooler (not shown) to a cooler return 31. Torque sensor 11 can raise or lower a system pressure 45 delivered by the hydraulic energy source, as a function of the torque that is present.

A second valve arrangement 13 is also connected downstream from hydraulic energy source 7. Second valve arrangement 13 is connected to conical disks indicated generally by reference numeral 15, and serves to adjust the positions of the conical disks, i.e., to set the transmission ratio of belt-driven conical-pulley transmission 3.

Also connected downstream from hydraulic energy source 7 is a third valve arrangement 17, which is connected to actuate a forward clutch, indicated generally by reference numeral 19 and a reverse clutch, indicated generally by reference numeral 21.

A hydraulic parking-lock release system 23 is also connected downstream from hydraulic energy source 7. The parking-lock release system 23 of hydraulic system 1 is connected to a mechanical parking lock, indicated generally by reference numeral 25. The connection can be effected by means of suitable mechanical aids, for example a lever. By means of the parking-lock release system 23, the mechanical parking lock 25 of motor vehicle 5 can be engaged, i.e., established, and released again.

Hydraulic energy source 7 also serves to supply a fourth valve arrangement 27. Fourth valve arrangement 27 serves to provide a volumetric flow of cooling oil that is likewise provided by means of hydraulic energy source 7. To that end, fourth valve arrangement 27 is connected to a cooling circuit, indicated generally by reference numeral 29, particularly to the cooler return 31, to an active Hytronic cooling system, indicated generally by reference numeral 33, to a jet pump, indicated generally by reference numeral 35, and to a centrifugal oil cover, indicated generally by reference numeral 37.

Hydraulic energy source 7 is connected downstream through a branch 39 to a pilot-pressure-regulating valve 41. Pilot pressure regulating valve 41 regulates a downstream pilot pressure 43, of around 5 bar, for example, while the hydraulic energy source 7 provides a higher system pressure 45. The pilot pressure serves in a known way by means of suitable proportional valves, for example electrically actuatable proportional valves, to control the circuit components of hydraulic system 1.

To set a maximum volumetric oil flow to torque sensor 11 and to limit excess oil conveyed to the cooler return 31, a fifth valve arrangement 47 is provided.

To set or regulate the system pressure 45 ahead of torque sensor 11, the latter includes pressure regulating valves (not shown). First valve arrangement 9 includes a system pressure valve 49 connected upstream of torque sensor 11. System pressure valve 49 is connected downstream from fifth valve arrangement 47, and allows an appropriate volumetric flow for torque sensor 11 to pass, while the system pressure 45 upstream can be adjusted to a minimum system pressure, for example 6 bar. To set an adjusting pressure through short-term additional elevation of the system pressure 45, system pressure valve 49 is additionally connected upstream to second valve arrangement 13 through an OR element 63.

Second valve arrangement 13 includes a seventh valve 51 that has a seventh control piston 53 and is connected downstream from hydraulic energy source 7. Seventh control piston 53 is connected downstream to an eighth valve 55 for actuation. The eighth valve 55 can be a control valve, for example an electrically actuatable proportional valve. Seventh valve 51 has a first port 57 and a second port 59, which are each connected to corresponding adjusting elements of the conical disks 15. By means of the seventh control piston 53 of the seventh valve 51, hydraulic energy source 7 can optionally be connected continuously, i.e., with transfer flow, to first port 57 or to second port 59. The particular port that is not connected to the hydraulic energy source 7 can accordingly be connected to a tank 61. In a middle position of control piston 53 both ports 57 and 59 can be disconnected from the hydraulic energy source 7 and switched to the tank 61. Thus, a desired pressure ratio can be set in ports 57 and 59 by means of the seventh valve 51 of second valve arrangement 13 to adjust the conical disks 15. In addition, ports 57 and 59 are connected to system pressure valve 49 through the OR element 63. Through that connection the minimum system pressure adjusted by means of system pressure valve 49 can be adapted by a desired amount to the seventh valve 51, i.e., raised by means of adjusting motions made by valve 49, for example.

Fourth valve arrangement 27 includes a cooling oil regulating valve 67 that is controlled by means of a fourth valve 65. Cooling oil regulating valve 67 is connected downstream from the fifth valve system 47, and is supplied thereby with hydraulic energy particularly by means of hydraulic energy source 7. In addition, fourth valve arrangement 27 has a return valve 69, which is connected upstream directly to hydraulic energy source 7 or to a pump injector 70 of hydraulic energy source 7. Return valve 69 is connected downstream with a direct connection to centrifugal oil cover 37 through a port of return valve 69, and as the volumetric flows rise it conveys a partial flow directly into the pump injector 70. Cooling oil regulating valve 67 serves to regulate and maintain a desired volumetric flow of cooling oil to the components that are to be cooled.

The third valve arrangement 17 includes a first valve 71 with a first control piston 73. To actuate the first control piston 73 it is connected to a downstream third valve 75, a control valve such as an electrically actuatable proportional valve, for example. The first control piston 73 of the first valve 71 can assume essentially three selector positions to actuate the forward clutch 19 and the reverse clutch 21. In a first selector position, which is shown in FIG. 1, in which the reverse clutch 21 is pressurized, a first port 77 of the first valve 71 is connected to the hydraulic energy source 7 by means of first control piston 73, the connection to the hydraulic energy source 7 being accomplished through a fifth valve 79. Fifth valve 79 is actuatable by means of a sixth valve 81, for example a control valve such as an electrically actuatable proportional valve, and serves to provide or control and/or regulate a pressure to selectively engage the clutches 19 and 21 that are connected downstream. If a torque to be transmitted is present, the pressure can be up to 20 bar, for example. Advantageously, the fifth valve 79 can also be used in the event of a problem, preferably in the case of an electric power failure, for example, to switch the downstream first valve 71 to zero pressure, i.e., to separate the hydraulic energy source 7 from the first valve 71. Preferably, to that end both the inlet of the first valve 71 and the outlet of the fifth valve 79 can be switched to the tank 61.

In a second selector position, which corresponds to a displacement of the first control piston 73 of first valve 71 to the right, as viewed in the orientation shown in FIG. 1, the connection to the upstream fifth valve 79 can be interrupted. At the same time, the first port 77 can be switched to the tank 61 by means of the first control piston 73 of first valve 71, so that the reverse clutch is depressurized. In addition, in that selector position the forward clutch 19 can also be switched to the tank 61 via a second port 83 of first valve 71.

In a third selector position, which corresponds to a further displacement of first control piston 71 to the right, as viewed in the orientation shown in FIG. 1, the second port 83 can be connected to the fifth valve 79 and the first port 77 to the tank 61. In that third selector position, which corresponds to an engaged forward gear of the motor vehicle 5, the forward clutch 19 is thus under pressure and the reverse clutch 21 is switched to zero pressure.

The connections of clutches 19, 21 can also be exchanged. It is also conceivable to arrange the three selector positions of first valve 71 in any order.

The parking-lock release system 23 includes a parking lock cylinder 85. Parking lock cylinder 85 can be biased toward the left, as viewed in the orientation shown in FIG. 1, by means of a return spring of the parking lock (not shown). Parking lock cylinder 85 can be moved to the right against that bias, as viewed in the orientation shown in FIG. 1, to release the parking lock 25. To apply the appropriate hydraulic force, one end face 87 of parking lock cylinder 85 is connected downstream from a second valve 89 of the parking-lock release system 23. To increase the system pressure 45 during the release of the parking lock 25, it is conceivable to simultaneously operate the seventh valve 51 of the second valve arrangement 13 in any desired adjusting direction, whereby the system pressure 45 is increased to up to 50 bar, for example, through the downstream-connected OR element 63 and the system pressure valve 49.

The second valve 89 of the parking-lock release system 23 is connected downstream from hydraulic energy source 7, while the end face 87 of parking lock cylinder 85 is directly connectable to the system pressure 45 of hydraulic energy source 7 by means of a second control piston 91 of second valve 89. The actuation of the second control piston 91 can be accomplished by means of the fourth valve 65 of the fourth valve arrangement 27, while the second control piston 91 is connected downstream to the fourth valve 65. The cooling oil regulating valve 67 and the second valve 89 are thus equally actuated by the fourth valve 65, while the parking lock 25 can be released while the cooling oil volumetric flow is simultaneously turned on, for example, and vice versa. It is also conceivable, however, to design the control surfaces and/or directions of action of the valves 67 and 89 differently, for example in such a way that the parking lock 25 is first released, and upon a further pressure increase of the fourth valve 65 the spool of the cooling oil regulating valve 67 is also operated to activate the cooling. With that design it is thus possible to release the parking lock 25 without simultaneously having to activate the cooling.

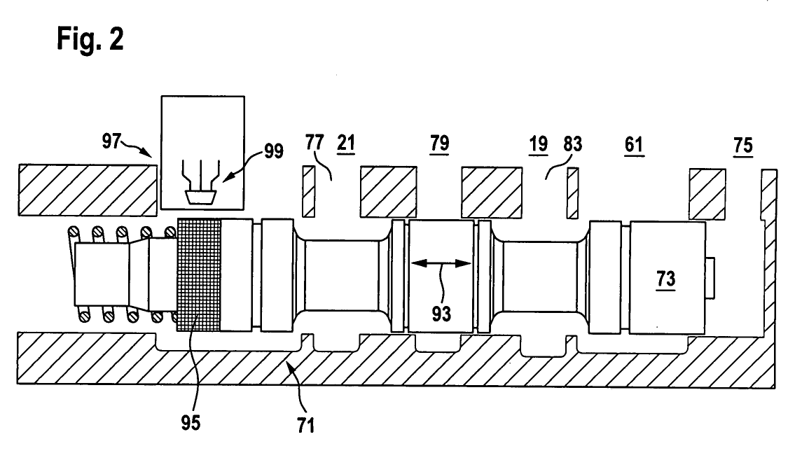

FIG. 2 shows a longitudinal cross-sectional view of the first valve 71 with the first control piston 73 as shown in FIG. 1. First control piston 73 can be moved to the right and left, as viewed in the orientation shown in FIG. 2 and as indicated by a double-headed arrow 93, to adjust the clutches 21 and 19. In FIG. 2 it can be seen that first control piston 73 includes a ring magnet 95, which can operate together with a sensor 99 to achieve a detector 97 to detect a position of second control piston 91. Sensor 99 can be a Hall-effect sensor, for example, which is positioned tangentially to ring magnet 95. For example, the position of first control piston 73 shown in FIG. 2 can be detected exactly by means of sensor 99. The position of the first control piston shown in FIG. 2 corresponds to a neutral position (N) of the belt-driven conical-pulley transmission 3, wherein the forward clutch 19 and the reverse clutch 21 are switched to zero pressure and blocked from the fifth valve 79. It is conceivable to exchange the actuation of the clutches 19 and 21.

It is possible by means of the hydraulic system shown in FIGS. 1 and 2 to replace formerly necessary manual selectors for clutch selection by the pilot-operated first control piston 73. The overall result is a hydraulic system 1 that requires the least possible construction space and a small number of solenoids and selector valves.

Referring again to FIG. 1, the fourth valve 65 is interconnected with the cooling oil regulating valve 67 and the second valve 89 in such a way that it can take over both the switching command for the parking lock cylinder 85 and the actuation of the cooling circuit 29.

The second valve 89 is fed by the system pressure 45, and thus can pressurize the parking lock cylinder 85 in any driving condition. Parking lock cylinder 85 works against an externally applied parking pawl and engaging spring, which pushes the parking lock cylinder 85 back into its initial position at the zero pressure condition. Advantageously, a comparatively large force can be achieved by applying the comparatively high system pressure 45, resulting in reliable disengagement of the parking lock 25.

Advantageously, in the event of an electric power failure both clutches can be switched to zero pressure automatically by means of fifth valve 79, while at the same time parking lock 25 can be released hydraulically, since in that case second valve 89 also switches parking lock cylinder 85 automatically to the tank 61; i.e., the motor vehicle 5 is secured against unintended rolling away.

As an additional safety monitoring element, first control piston 73 has sensor 99, for example a Hall-effect sensor. The sensor 99, shown in FIG. 2, reports to a control device provided to control hydraulic system 1 the position of first control piston 73, or also a direction of motion of control piston 73, when selecting the clutch. That makes it possible to detect an incorrect selection of the clutches 19 and 21 and/or a hanging of first control piston 73. Other sensors can be provided in addition to sensor 99, if necessary. In addition, the selected actuation of third valve 75 during normal operation can enable conclusions to be drawn about the position of first control piston 73.

Hydraulic system 1 in accordance with the invention provides the following functions for the hydraulic control: hydraulic actuation and selection of the forward and reverse clutches, cooling the clutches, moving the disk sets of the CVT transmission, biasing the disk sets of the CVT transmission, providing a volumetric flow of oil through the oil cooler, and control (releasing) of the parking lock. Advantageously, it is possible to replace a previously employed “manual” selector (clutch selection) with a pilot-operated selector. At the same time, a parking-lock release system can be added. Advantageously, comparatively few solenoid and selector valves are needed, enabling savings in both construction space and cost.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic system for controlling a belt-driven conical-pulley transmission of a motor vehicle, wherein the transmission has a variably adjustable transmission ratio, said hydraulic system comprising:
a first valve arrangement for providing pressurized hydraulic fluid for maintaining a contact pressure between pairs of conical disks and an endless torque-transmitting means of the belt-driven conical-pulley transmission;
a second valve arrangement for providing pressurized hydraulic fluid for controlling the transmission ratio of the belt-driven conical-pulley transmission; and
a hydraulic energy source to supply the hydraulic system with hydraulic energy;
wherein a third valve arrangement is included for providing pressurized hydraulic fluid to control operation of a forward clutch and operation of a reverse clutch.

2. A hydraulic system in accordance with claim 1, including a hydraulic parking-lock release system for controlling a parking lock.

3. A hydraulic system in accordance with claim 1, wherein the third valve arrangement includes a first valve having a first control piston for hydraulic actuation of the forward clutch and the reverse clutch.

4. A hydraulic system in accordance with claim 2, wherein the hydraulic parking-lock release system includes a second valve for hydraulic actuation of a parking lock cylinder positioned downstream from the second valve for mechanical actuation of the parking lock.

5. A hydraulic system in accordance with claim 3, wherein the third valve arrangement includes a third valve positioned upstream from the first valve to actuate the first control piston of the first valve.

6. A hydraulic system in accordance with claim 3, wherein by means of the first control piston of the first valve,
a first selector position (R) to apply hydraulic pressure to the reverse clutch and to switch the forward clutch to zero pressure,
a second selector position (N) to switch the forward clutch and the reverse clutch to zero pressure, and
a third selector position (D) to apply pressure to the forward clutch and to switch the reverse clutch to zero pressure are alternatively actuatable.

7. A hydraulic system in accordance with claim 4, wherein the hydraulic parking-lock release system includes a fourth valve positioned upstream from the second valve to actuate a second control piston of the second valve.

8. A hydraulic system in accordance with claim 6, including a detector for detecting the first, second, and third selector positions (R, N, D) of the first control piston.

9. A hydraulic system in accordance with claim 8, wherein the detector includes a Hall-effect sensor for detecting a position of the first control piston.

10. A hydraulic system in accordance with claim 3, wherein the first valve is connected upstream to the hydraulic energy source through a fifth valve.

11. A hydraulic system in accordance with claim 10, wherein the fifth valve is connected downstream of a sixth valve to actuate the fifth valve.

12. A hydraulic system in accordance with claim 1, including a fourth valve arrangement for controlling a volumetric flow of cooling oil to cool the clutches.

13. A hydraulic system in accordance with claim 12, wherein the fourth valve arrangement includes a fourth valve for actuation of a cooling oil regulating valve.

14. A belt-driven conical-pulley transmission having a hydraulic system in accordance with claim 1.

15. A motor vehicle having a belt-driven conical-pulley transmission in accordance with claim 14.
